(19) United States
(12) Patent Application Publication
(10) Pub. No.: US 2026/0249329 A1
(43) Pub. Date: Aug. 27, 2026

(54) CLEANING AND DRYING APPARATUS

(71) Applicant: Douyin Vision Co., Ltd., Beijing (CN)

(72) Inventors: Ting TIAN, Beijing (CN); Xuechao LIU, Beijing (CN); Tao LIU, Beijing (CN); Chenglong GUI, Beijing (CN); Chen SHEN, Beijing (CN); Tangbo JING, Beijing (CN); Yuanlin REN, Beijing (CN); Jian WANG, Beijing (CN)

(21) Appl. No.: 19/388,886

(22) Filed: Nov. 13, 2025

(30) Foreign Application Priority Data
Feb. 24, 2025 (CN) 202510205918.8

(51) Int. Cl. B08B 5/04; F26B 5/12

(52) U.S. Cl. CPC B08B 5/04; F26B 5/12

(57) ABSTRACT

The present disclosure relates to a cleaning and drying apparatus. A first communication structure is provided with a first liquid inlet, a first liquid outlet, and a second negative pressure port. The first liquid outlet is communicated with a liquid inlet port, the first liquid inlet is communicated with a liquid outlet, and a liquid inlet has a first communication position communicated with a liquid source and a second communication position disconnected from the liquid source. A negative pressure generating apparatus is provided with an air suction port communicated with both a first negative pressure port and the second negative pressure port. A switching control structure has a cleaning state, a liquid discharge state, and a drying state.

### CROSS REFERENCE TO RELATED APPLICATIONS

This present application claims the benefit of priority to Chinese Application No. 202510205918.8, filed on Feb. 24, 2025, the entire contents of which are incorporated herein by reference.

### TECHNICAL FIELD

The present disclosure relates to the technical field of cleaning and drying, and in particular, to a cleaning and drying apparatus.

### BACKGROUND

Liquid cooling apparatuses, such as a cold plate heat dissipation module and a cold plate server, need to be flushed with deionized water and thoroughly dried before shipment and relocation.

### SUMMARY

The present disclosure provides a cleaning and drying apparatus for cleaning and drying a liquid cooling apparatus, where the liquid cooling apparatus includes a liquid inlet and a liquid outlet, and the cleaning and drying apparatus includes a negative pressure tank, a first communication structure, a negative pressure generating apparatus, and a switching control structure. The negative pressure tank is provided with a negative pressure chamber, a first negative pressure port, and a liquid inlet port, and the first negative pressure port and the liquid inlet port are both communicated with the negative pressure chamber. The first communication structure is provided with a first communication chamber, a first liquid inlet, a first liquid outlet, and a second negative pressure port, and the first liquid inlet, the first liquid outlet, and the second negative pressure port are all communicated with the first communication chamber. The first liquid outlet is communicated with the liquid inlet port, the first liquid inlet is used for being communicated with the liquid outlet, and the liquid inlet has a first communication position communicated with a liquid source and a second communication position disconnected from the liquid source. The negative pressure generating apparatus is provided with an air suction port, and the air suction port is communicated with both the first negative pressure port and the second negative pressure port. The switching control structure has a cleaning state of controlling the second negative pressure port to be closed and controlling the first negative pressure port, the first liquid outlet, and the liquid inlet at the first communication position to be opened, a liquid discharge state of controlling the second negative pressure port to be closed and controlling the first negative pressure port, the first liquid outlet, and the liquid inlet at the second communication position to be opened, and a drying state of controlling the second negative pressure port to be opened and controlling the first negative pressure port, the first liquid outlet, and the liquid inlet to be closed.

When the switching control structure is in the cleaning state, the second negative pressure port is controlled to be closed, and the first negative pressure port, the first liquid outlet, and the liquid inlet at the first communication position are controlled to be opened. The negative pressure generating apparatus generates a negative pressure in the negative pressure chamber through the air suction port and the first negative pressure port. A cleaning liquid, such as clean deionized water or distilled water, from the liquid source enters the liquid cooling apparatus through the liquid inlet under the action of the negative pressure, and then enters the negative pressure chamber through the liquid outlet, to flush the liquid cooling apparatus. After flushing is completed, the switching control structure enters the liquid discharge state, in which the second negative pressure port is controlled to be closed, and the first negative pressure port, the first liquid outlet, and the liquid inlet at the second communication position are controlled to be opened. The liquid inlet is communicated with the external environment, and the negative pressure generating apparatus generates a negative pressure in the negative pressure chamber through the air suction port and the first negative pressure port. Deionized water in the liquid cooling apparatus and the first communication chamber is drawn into the negative pressure chamber under the action of the negative pressure, and at the same time, external air enters the liquid cooling apparatus and the first communication chamber through the liquid inlet, thereby achieving the purpose of preliminary self-suction and drying. After preliminary self-suction and drying, the switching control structure enters the drying state, in which the second negative pressure port is controlled to be opened, and the first negative pressure port, the first liquid outlet, and the liquid inlet are controlled to be closed. The negative pressure chamber is disconnected from the first communication chamber and the liquid cooling apparatus, and the negative pressure generating apparatus generates a negative pressure in the first communication chamber and the liquid cooling apparatus through the air suction port and the second negative pressure port. At this time, the pressure in the first communication chamber and the liquid cooling apparatus is absolute pressure, and the boiling point of the cleaning liquid, such as clean deionized water or distilled water, is reduced to room temperature. Then, the low-pressure environment formed by the negative pressure generating apparatus in the first communication chamber and the liquid cooling apparatus is utilized to force the water body to boil at room temperature, and the water vapor after boiling is discharged to the outside through the negative pressure generating apparatus, thereby achieving the purpose of drying at room temperature.

### BRIEF DESCRIPTION OF THE DRAWINGS

In order to more clearly illustrate the technical solutions in the specific embodiments of the present disclosure or in the related art, the following will briefly introduce the drawings that need to be used in the description of the specific embodiments or related art. Obviously, the drawings in the following description are some implementations of the present disclosure. For those of ordinary skill in the art, other drawings may be obtained based on these drawings without creative efforts.

FIG. 1 is a schematic diagram of a cleaning and drying apparatus (cleaning process) according to an embodiment of the present disclosure;

FIG. 2 is a schematic diagram of the cleaning and drying apparatus (liquid discharge from a negative pressure chamber) according to an embodiment of the present disclosure;

FIG. 3 is a schematic diagram of the cleaning and drying apparatus (drying process) according to an embodiment of the present disclosure;

FIG. 4 is a schematic diagram of the cleaning and drying apparatus (self-drying) according to an embodiment of the present disclosure; and

FIG. 5 is a schematic diagram of saturated vapor pressure in an atmospheric environment.

### REFERENCE NUMERALS

1: liquid cooling apparatus; 11: liquid inlet; 12: liquid outlet; 2: negative pressure tank; 21: negative pressure chamber; 22: first negative pressure port; 23: liquid inlet port; 24: first drain valve; 25: liquid discharge valve; 26: liquid level gauge; 3: first communication structure; 31: first communication chamber; 32: first liquid inlet; 33: first liquid outlet; 34: second negative pressure port; 4: liquid source; 5: negative pressure generating apparatus; 51: air suction port; 6: first control valve; 7: second control valve; 8: third control valve; 9: fourth control valve; 10: second communication structure; 101: second communication chamber; 102: second liquid inlet; 103: second liquid outlet; 104: second drain valve.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and comprehensively with reference to the drawings in the embodiments of the present disclosure. Obviously, the described embodiments are part of the embodiments of the present disclosure, but not all of the embodiments. Based on the embodiments in the present disclosure, all other embodiments obtained by those skilled in the art without creative efforts belong to the protection scope of the present disclosure.

In a factory production line shipment scenario, the conventional flushing and drying process is usually performed in a pipeline manner using several workstations. There is an interval time between each workstation, and process control is also involved. Therefore, the process takes a long time and quality problems easily occur. In addition, in a practical inspection process of a cold plate liquid cooling apparatus upon arrival, water is often found inside the cold plate.

Most of the conventional flushing and drying apparatuses use an air heating method for drying. However, during the air heating and drying process, it is easy to cause inconsistent drying effects due to different fin gaps and different water contents between cold plates, and it also causes high energy consumption.

In view of this, the present disclosure provides a cleaning and drying apparatus to solve the problems of long time and easy occurrence of quality problems in the workstation-type pipeline operation, and inconsistent drying effects and high energy consumption.

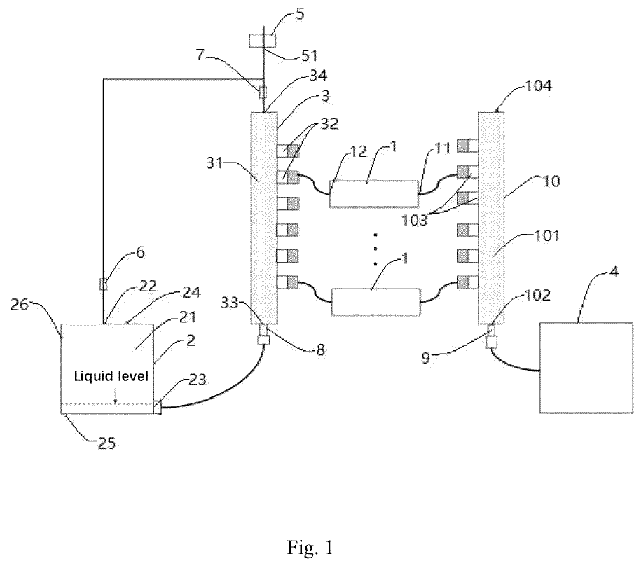

The embodiments of the present disclosure will be described below with reference to FIGS. 1 to 5.

According to an embodiment of the present disclosure, there is provided a cleaning and drying apparatus for cleaning and drying a liquid cooling apparatus 1, where the liquid cooling apparatus 1 includes a liquid inlet 11 and a liquid outlet 12, and the cleaning and drying apparatus includes a negative pressure tank 2, a first communication structure 3, a negative pressure generating apparatus 5, and a switching control structure. The negative pressure tank 2 is provided with a negative pressure chamber 21, a first negative pressure port 22, and a liquid inlet port 23, and the first negative pressure port 22 and the liquid inlet port 23 are both communicated with the negative pressure chamber 21. The first communication structure 3 is provided with a first communication chamber 31, a first liquid inlet 32, a first liquid outlet 33, and a second negative pressure port 34, and the first liquid inlet 32, the first liquid outlet 33, and the second negative pressure port 34 are all communicated with the first communication chamber 31. The first liquid outlet 33 is communicated with the liquid inlet port 23, the first liquid inlet 32 is used for being communicated with the liquid outlet 12, and the liquid inlet 11 has a first communication position communicated with a liquid source 4 and a second communication position disconnected from the liquid source 4. The negative pressure generating apparatus 5 is provided with an air suction port 51, and the air suction port 51 is communicated with both the first negative pressure port 22 and the second negative pressure port 34. The switching control structure has a cleaning state of controlling the second negative pressure port 34 to be closed and controlling the first negative pressure port 22, the first liquid outlet 33, and the liquid inlet 11 at the first communication position to be opened, a liquid discharge state of controlling the second negative pressure port 34 to be closed and controlling the first negative pressure port 22, the first liquid outlet 33, and the liquid inlet 11 at the second communication position to be opened, and a drying state of controlling the second negative pressure port 34 to be opened and controlling the first negative pressure port 22, the first liquid outlet 33, and the liquid inlet 11 to be closed.

The cleaning and drying apparatus provided by the present disclosure uses the negative pressure generating apparatus 5, the negative pressure tank 2, and the first communication structure 3 to flush the liquid cooling apparatus 1 based on the negative pressure principle, and dry the liquid cooling apparatus 1 at room temperature based on the principle that the boiling point of a cleaning liquid, such as clean deionized water or distilled water, is lowered in a negative pressure environment. In this way, one-stop and full-automatic flushing and drying is realized, the production line time is saved, and the relocation efficiency of the liquid cooling apparatus 1 is improved by avoiding the relocation of the liquid cooling apparatus 1 between a plurality of workstations. A good drying effect may be obtained in the case of different fin gaps and different water contents between cold plates, and the drying consistency at different positions of the liquid cooling apparatus 1 is high. In addition, since high energy consumption methods, such as air heating and air compression, are avoided for drying, the cleaning and drying apparatus provided by the present disclosure has a low energy efficiency.

When the switching control structure is in the cleaning state, the second negative pressure port 34 is controlled to be closed, and the first negative pressure port 22, the first liquid outlet 33, and the liquid inlet 11 at the first communication position are controlled to be opened. The negative pressure generating apparatus 5 generates a negative pressure in the negative pressure chamber 21 through the air suction port 51 and the first negative pressure port 22. A cleaning liquid, such as clean deionized water or distilled water, from the liquid source 4 enters the liquid cooling apparatus 1 through the liquid inlet 11 under the action of the negative pressure, and then enters the negative pressure chamber through the liquid outlet 12, to flush the liquid cooling apparatus 1. After flushing is completed, the switching control structure enters the liquid discharge state, in which the second negative pressure port 34 is controlled to be closed, and the first negative pressure port 22, the first liquid outlet 33, and the liquid inlet 11 at the second communication position are controlled to be opened. The liquid inlet 11 is communicated with the external environment, and the negative pressure generating apparatus 5 generates a negative pressure in the negative pressure chamber 21 through the air suction port 51 and the first negative pressure port 22. Deionized water in the liquid cooling apparatus 1 and the first communication chamber 31 is drawn into the negative pressure chamber under the action of the negative pressure, and at the same time, external air enters the liquid cooling apparatus 1 and the first communication chamber 31 through the liquid inlet 11, thereby achieving the purpose of preliminary self-suction and drying. After preliminary self-suction and drying, the switching control structure enters the drying state, in which the second negative pressure port 34 is controlled to be opened, and the first negative pressure port 22, the first liquid outlet 33, and the liquid inlet 11 are controlled to be closed. The negative pressure chamber 21 is disconnected from the first communication chamber 31 and the liquid cooling apparatus 1, and the negative pressure generating apparatus 5 generates a negative pressure in the first communication chamber 31 and the liquid cooling apparatus 1 through the air suction port 51 and the second negative pressure port 34. At this time, the pressure in the first communication chamber 31 and the liquid cooling apparatus 1 is absolute pressure, and the boiling point of the cleaning liquid, such as clean deionized water or distilled water, is lowered to room temperature. Then, the low-pressure environment formed by the negative pressure generating apparatus 5 in the first communication chamber 31 and the liquid cooling apparatus 1 is utilized to force the water body to boil at room temperature, and the water vapor after boiling is discharged to the outside through the negative pressure generating apparatus 5, thereby achieving the purpose of drying at room temperature, without using a relatively large air compressor or air heating apparatus, which saves energy while improving the drying effect.

In a specific embodiment, the negative pressure generating apparatus 5 may be a vacuum pump. The liquid cooling apparatus 1 may be a cold plate heat dissipation module or a cold plate server. The first liquid outlet 33 is communicated with the liquid inlet port 23 through a first pipeline. In a preferred implementation, the first pipeline may be a hose. The first liquid inlet 32 is communicated with the liquid outlet 12 through a second pipeline. In a preferred implementation, a quick connector is provided at the first liquid inlet 32, the second pipeline is detachably and quickly connected to the quick connector in a pluggable manner, and the second pipeline may also be quickly connected to the liquid outlet 12 in a pluggable manner. An interlocking self-sealing ball valve is provided at the liquid inlet port 23 of the negative pressure tank 2.

Specifically, as shown in FIG. 5, at different pressure levels, the cleaning liquid, such as clean deionized water or distilled water, has different boiling points. For example, at an absolute pressure of 3 Kpa, the boiling point is lowered to below 25 degrees. For example, at an absolute pressure of 2 Kpa, the boiling point of the cleaning liquid, such as clean deionized water or distilled water, is about 18 degrees. Deionized water is also known as pure water.

In an embodiment, the switching control structure includes a first control valve 6, and the first control valve 6 is provided at the first negative pressure port 22.

The first control valve 6 is used for controlling the first negative pressure port 22 to be opened or closed.

Specifically, the first control valve 6 is an electric valve.

In an embodiment, the switching control structure includes a second control valve 7, and the second control valve 7 is provided at the second negative pressure port 34.

The second control valve 7 is used for controlling the second negative pressure port 34 to be opened or closed.

Specifically, the second control valve 7 is an electric valve.

In an embodiment, the switching control structure includes a third control valve 8, and the third control valve 8 is provided at the first liquid outlet 33.

The third control valve 8 is used for controlling the first liquid outlet 33 to be opened or closed.

Specifically, the third control valve 8 is an electric valve. An interlocking self-sealing ball valve is also provided at the first liquid outlet 33.

In an embodiment, the switching control structure includes a fourth control valve 9, and the fourth control valve 9 is provided at the liquid inlet 11.

The fourth control valve 9 is used for controlling the liquid inlet 11 to be opened or closed.

Specifically, the fourth control valve 9 is an electric valve.

In an embodiment, as shown in FIGS. 1 to 4, the first negative pressure port 22 is provided at the top of the negative pressure chamber 21.

This prevents the liquid drawn into the negative pressure chamber 21 from entering the negative pressure generating apparatus 5 through the first negative pressure port 22, thereby avoiding damage to the negative pressure generating apparatus 5, and also ensures that the first negative pressure port 22 always has a good effect of drawing negative pressure.

In an embodiment, as shown in FIGS. 1 to 4, the negative pressure tank 2 further includes a first pressure relief port, a liquid discharge port, and a liquid level gauge 26. The first pressure relief port is provided at the top of the negative pressure tank 2 and communicated with the negative pressure chamber 21, and a first drain valve 24 is provided at the first pressure relief port. The liquid discharge port is provided at the bottom of the negative pressure tank 2 and communicated with the negative pressure chamber 21, and a liquid discharge valve 25 is provided at the liquid discharge port. The liquid level gauge 26 is provided on the negative pressure tank 2 for detecting the liquid level in the negative pressure chamber 21.

The liquid level gauge 26 detects the liquid level in the negative pressure chamber 21. When the detected liquid level is high, the first negative pressure port 22 is closed by the switching control structure, the negative pressure chamber 21 is disconnected from the negative pressure generating apparatus 5, the liquid discharge valve 25 and the first drain valve 24 are opened, and the liquid in the negative pressure chamber 21 is discharged through the liquid discharge port. During this process, the first pressure relief port realizes air pressure balance to ensure smooth discharge of the liquid. The liquid discharge valve 25 and the first drain valve 24 are only opened during the liquid discharge process of the negative pressure chamber 21, and are closed at other times to ensure the sealability of the negative pressure chamber 21.

Specifically, the first pressure relief port is provided at the top of the negative pressure tank 2, which may ensure that the liquid will not overflow through the first pressure relief port when the first drain valve 24 is opened. The liquid discharge port is provided at the bottom of the negative pressure tank 2, which may ensure a good and thorough liquid discharge effect of the negative pressure chamber 21.

In an embodiment, as shown in FIGS. 1 to 4, there are at least two first liquid inlets 32, part of the first liquid inlets 32 are communicated with the liquid outlet 12, and a first plugging head is detachably connected to the remaining first liquid inlet(s) 32.

At least two first liquid inlets 32 are provided, so that the cleaning and drying apparatus may clean and dry a plurality of liquid cooling apparatuses 1 at the same time, thereby saving energy consumption and improving the cleaning and drying efficiency. The first plugging head is connected to the unused first liquid inlet 32, which may prevent the liquid from overflowing during cleaning and ensure the sealability during drying.

In an embodiment, as shown in FIGS. 1 to 4, the second negative pressure port 34 is provided at the top of the first communication chamber 31.

This prevents the liquid drawn into the second communication chamber 101 from entering the negative pressure generating apparatus 5 through the second negative pressure port 34, thereby avoiding damage to the negative pressure generating apparatus 5, and also ensures that the second negative pressure port 34 always has a good effect of drawing negative pressure.

In an embodiment, as shown in FIGS. 1 to 4, the cleaning and drying apparatus further includes a second communication structure 10, which is provided with a second communication chamber 101, a second liquid inlet 102, and a second liquid outlet 103, where the second liquid inlet 102 and the second liquid outlet 103 are both communicated with the second communication chamber 101. The second liquid inlet 102 is used for being communicated with the liquid source 4, the second liquid outlet 103 is used for being communicated with the liquid inlet 11, and the switching control structure is used for controlling the on-off of the second liquid inlet 102.

Specifically, the fourth control valve 9 is provided at the second liquid inlet 102, and the interlocking self-sealing ball valve is also provided at the second liquid inlet 102. The second liquid inlet 102 is communicated with the liquid source 4 through a third pipeline. In a preferred implementation, the third pipeline is a hose. The second liquid outlet 103 is communicated with the liquid inlet 11 through a fourth pipeline. In a preferred implementation, a quick connector is provided at the second liquid outlet 103, the fourth pipeline is detachably and quickly connected to the quick connector in a pluggable manner, and the fourth pipeline may also be quickly connected to the liquid inlet 11 in a pluggable manner.

In an embodiment, as shown in FIGS. 1 to 4, a second pressure relief port is provided at the top of the second communication structure 10, the second pressure relief port is communicated with the second communication chamber 101, and a second drain valve 104 is provided at the second pressure relief port.

The second drain valve 104 is used for controlling the second pressure relief port to be opened or closed.

In an embodiment, as shown in FIGS. 1 to 4, there are at least two second liquid outlets 103, part of the second liquid outlets 103 are communicated with the liquid inlet 11, and a second plugging head is detachably connected to the remaining second liquid outlet(s) 103.

At least two second liquid outlets 103 are provided, so that the cleaning and drying apparatus may clean and dry a plurality of liquid cooling apparatuses 1 at the same time, thereby saving energy consumption and improving the cleaning and drying efficiency. The second plugging head is connected to the unused second liquid outlet 103, which may prevent the liquid from overflowing during cleaning and ensure the sealability during drying.

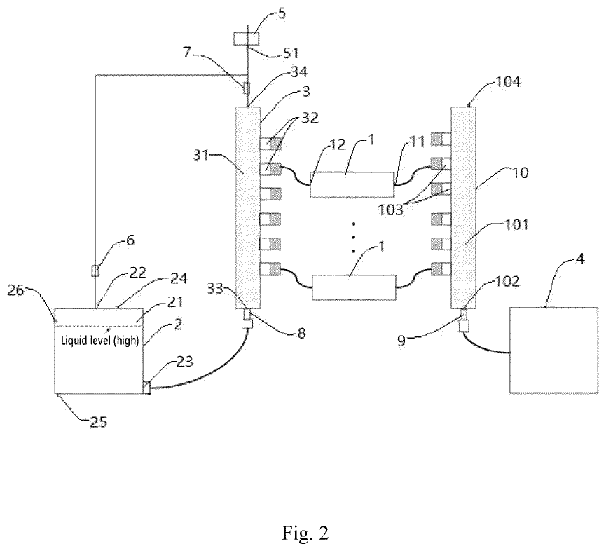

The cleaning process of the cleaning and drying apparatus provided in this embodiment includes: as shown in FIG. 1, closing the second negative pressure port 34 by the second control valve 7, opening the first negative pressure port 22 by the first control valve 6, opening the first liquid outlet 33 by the third control valve 8, opening the second liquid inlet 102 by the fourth control valve 9, and communicating the second liquid inlet 102 with the liquid source 4. The negative pressure generating apparatus 5 generates a negative pressure in the negative pressure chamber 21 through the air suction port 51 and the first negative pressure port 22. A cleaning liquid, such as clean deionized water or distilled water, from the liquid source 4 enters the second communication chamber 101 through the second liquid inlet 102 under the action of the negative pressure, and then enters the liquid cooling apparatus 1 through the second liquid outlet 103 and the liquid inlet 11, and then enters the negative pressure chamber through the liquid outlet 12, to flush the liquid cooling apparatus 1. During the cleaning process, the liquid level is detected by the liquid level gauge 26, and when the liquid level is high, as shown in FIG. 2, the first negative pressure port 22 is closed by the first control valve 6 to disconnect the negative pressure chamber 21 from the negative pressure generating apparatus 5, the liquid discharge valve 25 and the first drain valve 24 are opened, and the liquid in the negative pressure chamber 21 is discharged through the liquid discharge port. After the liquid discharge is completed, the first negative pressure port 22 is opened by the first control valve 6, and the cleaning and drying apparatus continues to flush the liquid cooling apparatus 1.

The preliminary self-suction and drying process of the cleaning and drying apparatus provided in this embodiment includes: after flushing is completed, closing the second negative pressure port 34 by the second control valve 7, opening the first negative pressure port 22 by the first control valve 6, opening the first liquid outlet 33 by the third control valve 8, opening the second liquid inlet 102 by the fourth control valve 9, disconnecting the second liquid inlet 102 from the liquid source 4, and communicating the liquid inlet 11 with the external environment through the second communication structure 10. The negative pressure generating apparatus 5 generates a negative pressure in the negative pressure chamber 21 through the air suction port 51 and the first negative pressure port 22. Deionized water in the liquid cooling apparatus 1, the first communication chamber 31, and the second communication chamber 101 is drawn into the negative pressure chamber under the action of the negative pressure, and at the same time, external air enters the second communication chamber 101 through the second liquid inlet 102, and then enters the liquid cooling apparatus 1 and the first communication chamber 31 through the liquid inlet 11, thereby achieving the purpose of preliminary self-suction and drying.

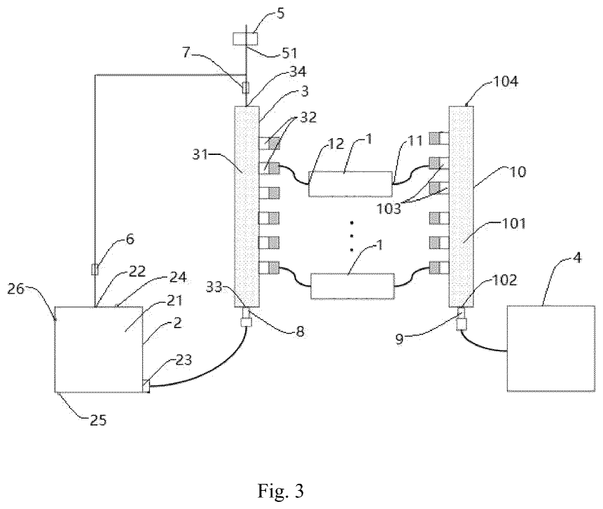

The drying process of the cleaning and drying apparatus provided in this embodiment includes: as shown in FIG. 3, after preliminary self-suction and drying, opening the second negative pressure port 34 by the second control valve 7, closing the first negative pressure port 22 by the first control valve 6, closing the first liquid outlet 33 by the third control valve 8, and closing the second liquid inlet 102 by the fourth control valve 9. The negative pressure generating apparatus 5 generates a negative pressure in the first communication chamber 31, the liquid cooling apparatus 1, and the second communication chamber 101 through the air suction port 51 and the second negative pressure port 34. At this time, the pressure in the first communication chamber 31, the liquid cooling apparatus 1 is absolute pressure, and the second communication chamber 101 is reduced, and the boiling point of the cleaning liquid, such as clean deionized water or distilled water, is lowered to room temperature. Then, the low-pressure environment formed by the negative pressure generating apparatus 5 in the first communication chamber 31, the liquid cooling apparatus 1, and the second communication chamber 101 is utilized to force the water body to boil at room temperature, and the water vapor after boiling is discharged to the outside through the negative pressure generating apparatus 5.

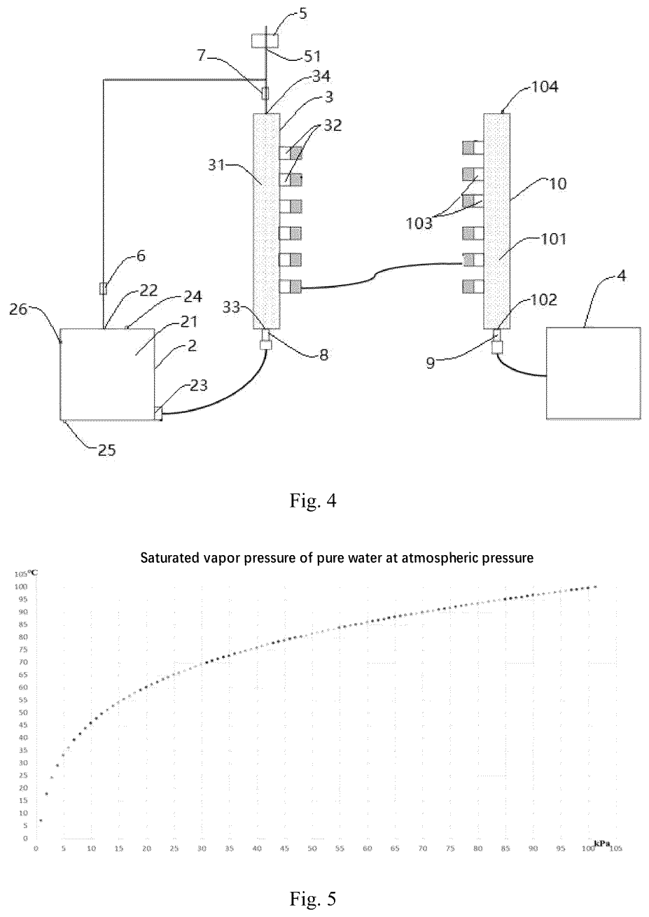

Further, when the liquid cooling apparatus 1 is not connected, as shown in FIG. 4, the first communication structure 3 is communicated with the second communication structure 10 through a pipeline, and the first communication structure 3 and the second communication structure 10 may also be self-dried.

Although the embodiments of the present disclosure are described in combination with the drawings, those skilled in the art may make various modifications and variations without departing from the spirit and scope of the present disclosure, and such modifications and variations fall within the scope defined by the appended claims.

1. A cleaning and drying apparatus for cleaning and drying a liquid cooling apparatus (1), wherein the liquid cooling apparatus (1) comprises a liquid inlet (11) and a liquid outlet (12); and the cleaning and drying apparatus comprises:
a negative pressure tank (2) provided with a negative pressure chamber (21), a first negative pressure port (22), and a liquid inlet port (23), wherein the first negative pressure port (22) and the liquid inlet port (23) are both communicated with the negative pressure chamber (21);
a first communication structure (3) provided with a first communication chamber (31), a first liquid inlet (32), a first liquid outlet (33), and a second negative pressure port (34), wherein the first liquid inlet (32), the first liquid outlet (33), and the second negative pressure port (34) are all communicated with the first communication chamber (31); the first liquid outlet (33) is communicated with the liquid inlet port (23), the first liquid inlet (32) is configured for being communicated with the liquid outlet (12), and the liquid inlet (11) has a first communication position communicated with a liquid source (4) and a second communication position disconnected from the liquid source (4);
a negative pressure generating apparatus (5) provided with an air suction port (51), wherein the air suction port (51) is communicated with both the first negative pressure port (22) and the second negative pressure port (34);
a switching control structure having a cleaning state of controlling the second negative pressure port (34) to be closed and controlling the first negative pressure port (22), the first liquid outlet (33), and the liquid inlet (11) at the first communication position to be opened, a liquid discharge state of controlling the second negative pressure port (34) to be closed and controlling the first negative pressure port (22), the first liquid outlet (33), and the liquid inlet (11) at the second communication position to be opened, and a drying state of controlling the second negative pressure port (34) to be opened and controlling the first negative pressure port (22), the first liquid outlet (33), and the liquid inlet (11) to be closed.

2. The cleaning and drying apparatus of claim 1, wherein the switching control structure comprises a first control valve (6), and the first control valve (6) is provided at the first negative pressure port (22).

3. The cleaning and drying apparatus of claim 1, wherein the switching control structure comprises a second control valve (7), and the second control valve (7) is provided at the second negative pressure port (34).

4. The cleaning and drying apparatus of claim 1, wherein the switching control structure comprises a third control valve (8), and the third control valve (8) is provided at the first liquid outlet (33).

5. The cleaning and drying apparatus of claim 1, wherein the switching control structure comprises a fourth control valve (9), and the fourth control valve (9) is provided at the liquid inlet (11).

6. The cleaning and drying apparatus of claim 1, wherein the first negative pressure port (22) is provided at the top of the negative pressure chamber (21).

7. The cleaning and drying apparatus of claim 1, wherein the negative pressure tank (2) further comprises:
a first pressure relief port provided at the top of the negative pressure tank (2) and communicated with the negative pressure chamber (21), wherein a first drain valve (24) is provided at the first pressure relief port;
a liquid discharge port provided at the bottom of the negative pressure tank (2) and communicated with the negative pressure chamber (21), wherein a liquid discharge valve (25) is provided at the liquid discharge port;
a liquid level gauge (26) provided on the negative pressure tank (2) for detecting a liquid level in the negative pressure chamber (21).

8. The cleaning and drying apparatus of claim 1, wherein at least one of: there are at least two first liquid inlets (32), part of the first liquid inlets (32) are communicated with the liquid outlet (12), and a first plugging head is detachably connected to the remaining first liquid inlet(s) (32); or
the second negative pressure port (34) is provided at the top of the first communication chamber (31).

9. The cleaning and drying apparatus of claim 1, further comprising a second communication structure (10) provided with a second communication chamber (101), a second liquid inlet (102), and a second liquid outlet (103), wherein the second liquid inlet (102) and the second liquid outlet (103) are both communicated with the second communication chamber (101); the second liquid inlet (102) is configured for being communicated with the liquid source (4), the second liquid outlet (103) is configured for being communicated with the liquid inlet (11), and the switching control structure is configured for controlling on-off of the second liquid inlet (102).

10. The cleaning and drying apparatus of claim 9, wherein at least one of: a second pressure relief port is provided at the top of the second communication structure (10), the second pressure relief port is communicated with the second communication chamber (101), and a second drain valve (104) is provided at the second pressure relief port; or
there are at least two second liquid outlets (103), part of the second liquid outlets (103) are communicated with the liquid inlet (11), and a second plugging head is detachably connected to the remaining second liquid outlet(s) (103).
